(19) United States
(12) Patent Application Publication
(10) Pub. No.: US 2007/0024721 A1
(43) Pub. Date: Feb. 1, 2007

(54) Compensating for improperly exposed areas in digital images

(76) Inventor: Sean Scott Rogers, San Diego, CA (US)

Correspondence Address: QUALCOMM INCORPORATED, 5775 MOREHOUSE DR., SAN DIEGO, CA, 92121, US

(21) Appl. No.: 11/193,250

(22) Filed: Jul. 29, 2005

(51) Int. Cl. H04N 5/235

(52) U.S. Cl. 348/229.1

(57) ABSTRACT

A method and apparatus compensates for improperly exposed areas in a first digital image taken with a first aperture setting by rapidly and automatically capturing a second digital image of the same scene using a second aperture setting. If a portion of the first image is properly exposed, then image information for the portion is used in a third adjusted image. If the portion is improperly exposed, then image information for the portion is combined with image information for a corresponding portion in the second image, thereby generating a composite portion used in the adjusted image. The manner of combining can be based on the luminance of the portion in the first image. In another example, one image is captured. Improperly exposed portions are adjusted using a screening process. The adjusted image is stored as a file with an indication in the file header that the image has been adjusted.

### BACKGROUND

1. Field

The disclosed embodiments relate generally to digital image processing.

2. Background

Digital images, such as those captured by digital cameras, can have exposure problems. Consider, for example, the use of a conventional digital camera on a bright sunny day. The camera is pointed upwards to capture a scene involving the tops of graceful trees. The trees in the foreground are set against a bright blue background of a beautiful summer sky. The digital image to be captured involves two portions, a tree portion and a background sky portion.

If the aperture of the camera is set to admit a large amount of light, then the tree portion will contain detail. Subtle color shading will be seen within the trunks and foliage of the trees in the captured image. The individual sensors of the image sensor that detect the tree portion of the image are not saturated. The individual sensors that detect the sky portion of the image, however, may receive so much light that they become saturated. As a consequence, the sky portion of the captured image appears so bright that subtle detail and shading in the sky is not seen in the captured image. The sky portion of the image may said to be “overexposed.”

If, on the other hand, the aperture of the camera is set to reduce the amount of light entering the camera, then the individual sensors that capture the sky portion of the image will not be saturated. The captured image shows the subtle detail and shading in the sky. Due to the reduced aperture, however, the tree portion of the image may appear as a solid black or very dark feature. Detail and shading within the tree portion of the image is now lost. The tree portion of the image may said to be “underexposed.”

It is therefore seen that with one aperture setting, a first portion of a captured image is overexposed whereas a second portion is properly exposed. With a second aperture setting, the first portion is properly exposed, but the second portion is underexposed. A solution is desired.

### SUMMARY INFORMATION

A method compensates for improperly exposed areas in a first digital image taken with a first aperture setting by rapidly and automatically capturing a second digital image of the same scene using a second aperture setting. An optical characteristic is determined for each portion of the first digital image. The optical characteristic may, for example, be the luminance of the portion. If the optical characteristic is in an acceptable range (for example, the luminance or the portion is high enough), then image information for the portion of the first digital image is used in a third adjusted digital image. If, on the other hand, the optical characteristic of the portion of the first digital image is outside the acceptable range (for example, the luminance of the portion is too low or too high), then image information for the portion in the first digital image is combined with image information for a corresponding portion in the second image, thereby generating a composite portion. The composite portion is used in the third adjusted digital image.

The manner of combining can be based on the luminance of the portion in the first image. In one example, the portion in the first digital image is mixed with the corresponding portion in the second digital image, and the relative proportion taken from the first digital image versus the second digital image is dependent on the magnitude of the optical characteristic. A multiplication factor representing this proportion is generated and the multiplication facture is used in the combining operation. This process of analyzing a portion in the first digital image and of generating a corresponding portion in the third adjusted digital image is performed for each portion of the first digital image. The resulting third digital image is stored as a file (for example, a JPEG file). A header of the file contains an indication that the compensating method has been performed on the image information contained in the file.

The method can be performed such that a portion of the first digital image is analyzed and a composite portion of the third digital image is generated before a second portion of the first digital image is analyzed. Alternatively, all of the portions of the first digital image can be analyzed in a first step thereby generating a two-dimensional array of multiplication factors for the corresponding two-dimensional array of portions of the first image. The multiplication factors are then used in a second step to combine corresponding portions of the first and second digital images to generate a corresponding two-dimension array of composite portions of the third digital image. In the case where a two-dimensional array of multiplication factors is generated, the multiplication factors can be adjusted to reduce an abruptness in transitions in multiplication factors between neighboring portions. This abruptness is a sharp discontinuity in multiplication factors as multiplication factors of portions disposed along a line are considered. Reducing such an abruptness makes boundaries between bright areas and dark areas in the resulting third digital image appear more natural. Reducing such an abruptness may also make undesirable “halo” effects less noticeable.

In accordance with another method, multiple digital images need not be captured in order to compensate for underexposed and/or overexposed areas in a digital image. A first digital image is captured using a relatively small aperture opening such that if a portion of the image is overexposed or underexposed it will most likely be underexposed. An optical characteristic is determined for the portion. If the optical characteristic is in a first range, then the portion of the first digital image is included in a second adjusted digital image in unaltered form. If, however, the optical characteristic is in a second range, then an optical characteristic adjustment process is performed on the portion of the first digital image to generate a modified portion. The modified portion is included in the second adjusted digital image.

In one example, the optical characteristic is luminance and the optical characteristic adjustment process is an iterative screening process. If the luminance of the portion is high enough, then the image information of the portion of the first digital image is used as the image information for the corresponding portion in the second adjusted digital image. If, on the other hand, the luminance of the portion is low, then the iterative screening process is performed to raise the luminance of the portion, thereby generating a modified portion having a higher luminance. The screening process raises the luminance of the portion while maintaining the relative proportions of the constituent red, green and blue colors in the starting portion. The modified portion is included in the second adjusted digital image. The iterative screening process is performed until either the luminance of the portion reaches a predetermined threshold, or until the screening process has been performed a predetermined maximum number of times. In this way, a second adjusted digital image is generated wherein areas that were dark in the first digital image are brighter in the second adjusted digital image. The second adjusted digital image is stored as a file (for example, a JPEG file). A header of the file contains an indication that the compensating method has been performed on the image information contained in the file.

A novel electronic circuit that carries out the novel methods is also disclosed. Additional embodiments are also described in the detailed description below.

### BRIEF DESCRIPTION OF THE DRAWINGS

FIG. 1 is a simplified diagram of one type of electronic device usable for carrying out a method in accordance with a first novel aspect.

FIG. 2 is a simplified flowchart of the method carried out by the electronic device of FIG. 1.

FIG. 3 is a simplified diagram of the variable aperture in the electronic device of FIG. 1, wherein the variable aperture has a first aperture setting.

FIG. 4 is a diagram of a first digital image captured using the first aperture setting.

FIG. 5 is a simplified diagram of the variable aperture in the electronic device of FIG. 1, wherein the variable aperture has a second aperture setting.

FIG. 6 is a diagram of a second digital image captured using the second aperture setting.

FIG. 7 is a graph of a function usable to determine how to combine a portion of the first digital image and a corresponding portion of the second digital image.

FIG. 8 is a diagram that identifies a neighborhood of portions in the first digital image.

FIG. 9 is an expanded view of the neighborhood of portions of FIG. 8.

FIG. 10 is a diagram of a two-dimensional array of multiplication factors for the neighborhood of portions of FIG. 9.

FIG. 11 is a diagram of the two-dimensional array of multiplication factors of FIG. 10 after some multiplication factors in the array have been adjusted to reduce an abruptness of transitions in multiplication factors between neighboring portions.

FIG. 12 is a diagram of a third digital image generated in accordance with the first novel aspect.

FIG. 13 is a flowchart of a method in accordance with a second novel aspect.

### DETAILED DESCRIPTION

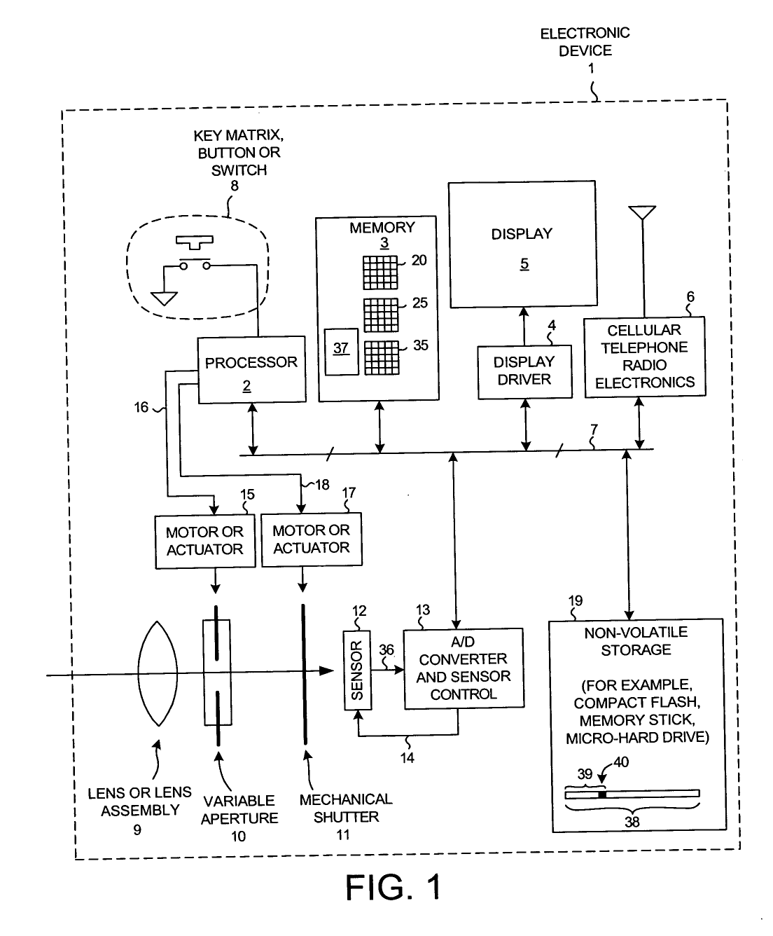

FIG. 1 is a high level simplified block diagram of an electronic device 1 usable for carrying out a method in accordance with one novel aspect. Electronic device 1 in this example is a cellular telephone. Electronic device 1 includes a processor 2, memory 3, a display driver 4, a display 5, and cellular telephone radio electronics 6. Processor 2 executes instructions 37 stored in memory 3. Processor 2 communicates with and controls display 5 and radio electronics via bus 7. Although bus 7 is illustrated here as a parallel bus, one or more buses both parallel and serial may be employed. The switch symbol 8 represents switches such as the keys on a key matrix, pushbuttons, or switches from which the electronic device receives user input. A user may, for example, enter a telephone number to be dialed using various keys on key matrix 8. Processor 2 detects which keys have been pressed, causes the appropriate information to be displayed on display 5, and controls the cellular telephone radio electronics 6 to establish a communication channel used for the telephone call.

Although electronic device 1 has been described above in the context of cellular telephones, electronic device 1 may also include digital camera electronics. The digital camera electronics includes a lens or lens assembly 9, a variable aperture 10, a mechanical shutter 11, an image sensor 12, and an analog-to-digital converter and sensor control circuit 13. Image sensor 12 may, for example, be a charge coupled device (CCD) image sensor or a CMOS image sensor that includes a two-dimensional array of individual image sensors. Each individual sensor detects light of a particular color. Typically, there are red sensors, green sensors, and blue sensors. The term pixel is sometimes used to describe a set of one red, one green and one blue sensor. A/D converter circuit 13 can cause the array of individual sensors to capture an image by driving an appropriate electronic shutter signal into the image sensor. A/D converter circuit 13 can then read the image information captured in the two-dimensional array of individual sensors out of image sensor 12 by driving appropriate readout pulses into image sensor 12 via lines 14. The captured image data flows in serial fashion from sensor 12 to A/D converter circuit 13 via leads 36. An electrical motor or actuator 15 is operable to open or constrict variable aperture 10 so that the aperture can be set to have a desired opening area. Processor 2 controls the motor or actuator 15 via control signals 16. Similarly, an electrical motor or actuator 17 is operable to open and close mechanical shutter 11. Processor 2 controls the motor or actuator 17 via control signals 18. Electronic device 1 also includes an amount of nonvolatile storage 19. Nonvolatile storage 19 may, for example, be flash memory or a micro-hard drive.

To capture a digital image, processor 2 sets the opening area size of variable aperture 10 using control signals 16. Once the aperture opening size is set, processor 2 opens mechanical shutter 11 using control signals 18. Light passes through lens 9, through the opening in variable aperture 10, through mechanical shutter 11, and onto image sensor 12. A/D converter and control circuit 13 supplies the electronic shutter signal to image sensor 12, thereby causing the individual sensors within image sensor 12 to capture image information. A/D converter and control circuit 13 then reads the image information out of sensor 12 using readout pulses supplied via lines 14, digitizes the information, and writes the digital image information into memory 3 across bus 7. Processor 2 retrieves the digital image information from memory 3, performs any desired image processing on the information, and then stores the resulting image as a file 38 in non-volatile storage 19. The digital image may, for example, be stored as a JPEG file. Processor 2 also typically causes the image to be displayed on display 5. The user can control camera functionality and operation, as well as cellular telephone functionality and operation, using switches 8.

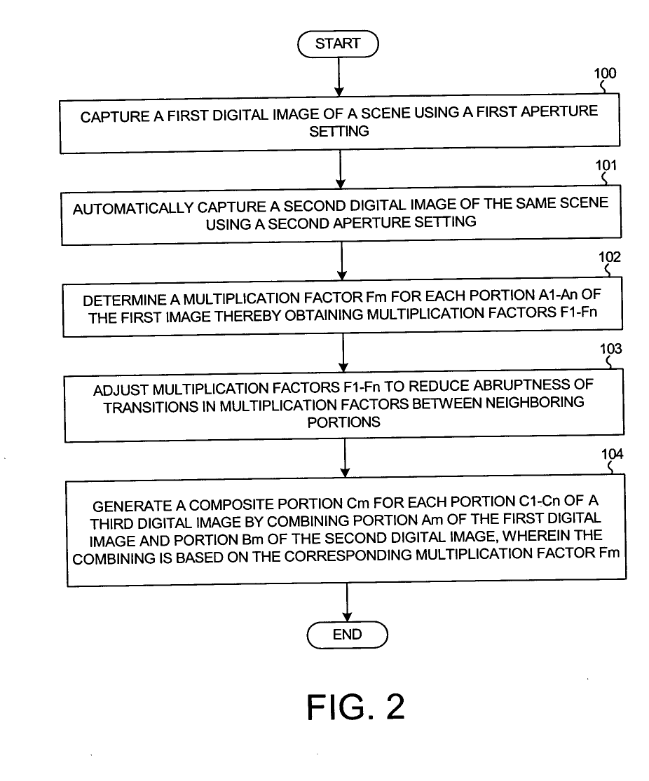

FIG. 2 is a simplified flowchart of a method carried out by the electronic device of FIG. 1. In a first step (step 100), a first digital image of a scene is captured using a first aperture setting. Processor 2 controls variable aperture 10 and mechanical shutter 11 accordingly.

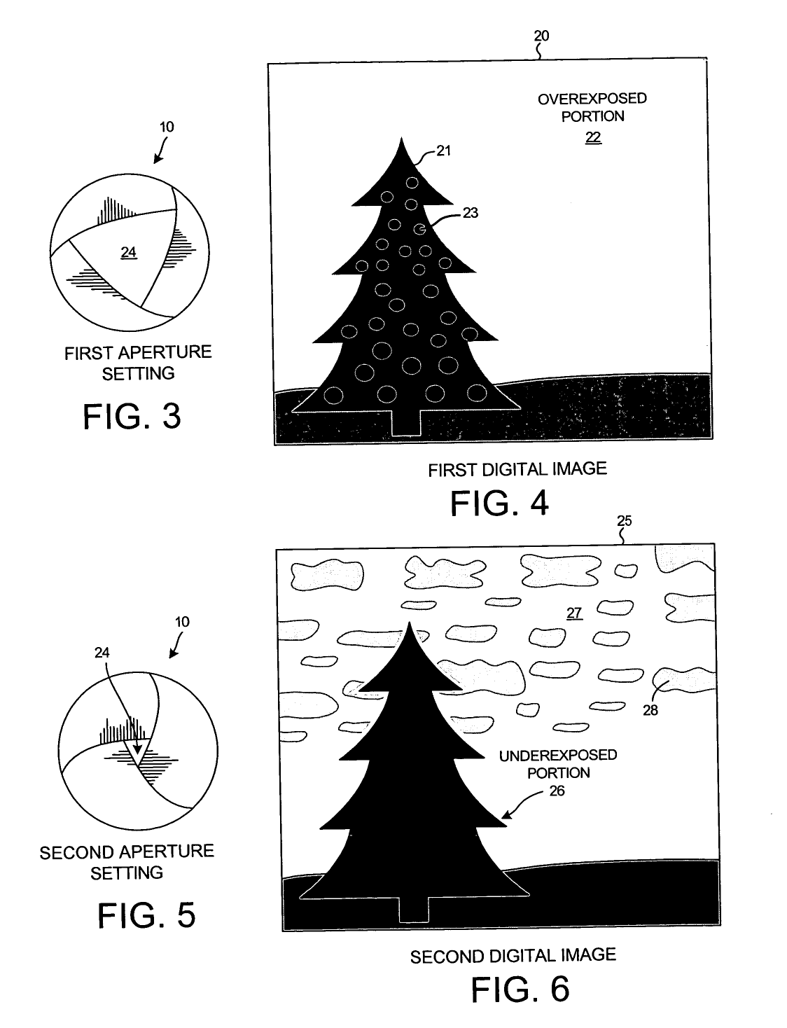

FIG. 3 is a simplified diagram of variable aperture 10.

FIG. 4 is a diagram of the resulting first digital image 20. First digital image 20 includes a first portion 21 and a second portion 22. First portion 21 in this example is an image of a tree in the foreground of the scene. Second portion 22 is an image of a relatively bright sky that constitutes the background of the scene. The tree appears as a relatively dark object in comparison with the relatively bright sky. The individual sensors of image sensor 12 that captured the first portion 21 were not saturated. Detail and shading is therefore present in first portion 21. The decorative balls 23 on the tree in FIG. 4 represent such detail and shading in first portion 21.

The individual sensors of image sensor 12 that captured the second portion 22, however, were substantially saturated due to the brightness of the sky. Relative color information and detail that should have been captured in this second portion 22 has therefore been lost. This lack of detail and shading in the background sky in FIG. 4 is represented by the solid white shading of second portion 22. Second portion 22 is said to be “overexposed.”

In a second step (step 101), a second digital image of the same scene is automatically captured by electronic device 1 using a second aperture setting. The second digital image is captured automatically and as soon as possible after the first digital image so that the locations of the various objects in the scene will be identical or substantially identical in the first and second digital images.

FIG. 5 is a simplified diagram of variable aperture 10. Note that the opening 24 in variable aperture 10 has a smaller area in FIG. 5 than in FIG. 3.

FIG. 6 is a diagram of the resulting second digital image 25. Second digital image 25 includes a first portion 26 and a second portion 27. First portion 26 is an image of the same tree that appears in the first digital image of FIG. 4. First portion 26 in the second digital image, however, appears as a black or very dark object. The detail and shading represented by decorative balls 23 in FIG. 4 are not present in first portion 26 in FIG. 6. First portion 26 is said to be “underexposed.”

The reduced area of opening 24 has, however, resulted in the proper exposure of the individual sensors that captured the relatively bright background sky. Whereas the second portion 22 of the first digital image 20 of FIG. 4 contains little or no detail or shading, the second portion 27 of the second digital image 25 of FIG. 6 shows the detail and subtle shading. The illustrated clouds 28 in the sky in FIG. 6 represent such detail and shading. The reduced area of opening 24 has resulted in second portion 27 being properly exposed. At this point in the method, both the first and second digital images 20 and 25 are present in memory 3 in the electronic device 1 of FIG. 1.

Next step (step 102), processor 2 determines a multiplication factor Fm for each portion A1-An of the first digital image. The image information of the first digital image is considered in portions that make up a two dimensional array of portions A1-An. In the present example, each portion is a pixel and the two dimensional array of the pixels forms the first digital image. Each pixel is represented by three individual color values: a red color value, a green color value, and a blue color value. Each value is a value between 0 and 255. A value of 0 indicates dark, whereas a value of 255 indicates completely bright. In step 102, each of the portions Am, where m ranges from one to n, is considered one at a time and a multiplication factor Fm is determined for the portion Am.

The multiplication factor can be determined in any one of many different suitable ways. In the present example, the multiplication factor Fm is determined by first determining the luminance L of the pixel. From the red color value (R), the green color value (G) and the blue color value (B), a luminance value L of the pixel is given by Equation (1) below. Equation (1) boosts the brightness for certain colors, while limiting the brightness of others, so that the magnitude of the resulting luminance value L corresponds to the brightness of the composite pixel as perceived by the human eye.
(R*0.30)+(G*0.59)+(B*0.11)=L (1)

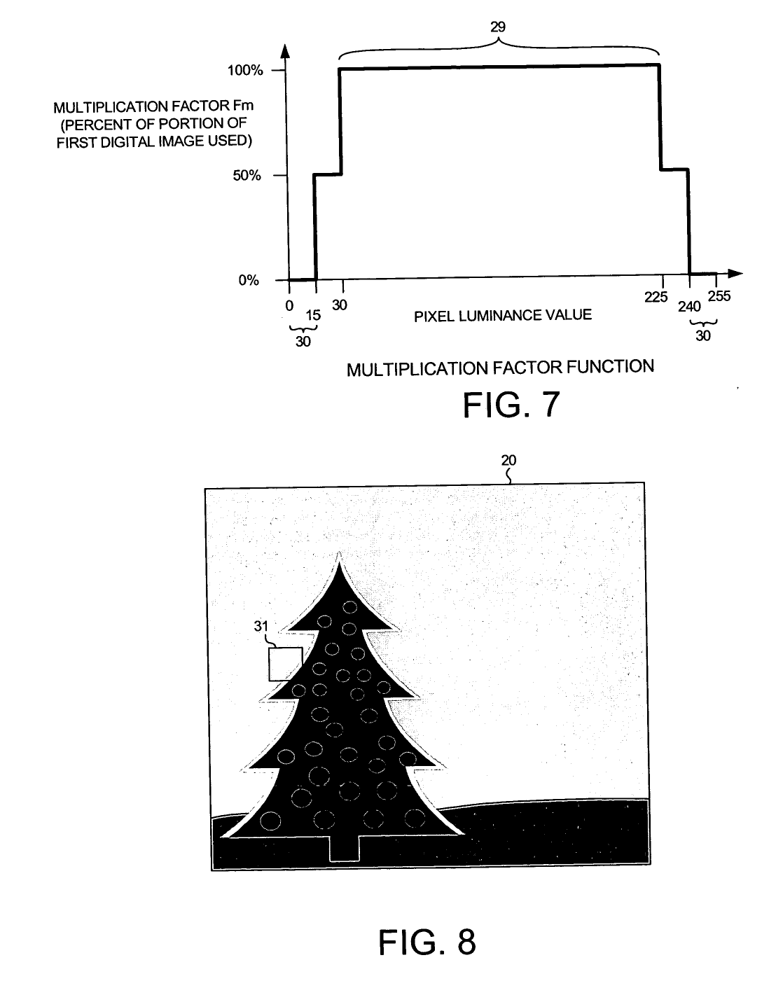

Once the luminance value L of the pixel has been determined, a multiplication factor function is used to determine the multiplication factor F for the pixel being considered. FIG. 7 is a graph of one such multiplication factor function. The horizontal axis of the graph is the pixel luminance value L. The pixel luminance value L is in a range from 0 (totally dark) to 255 (full brightness). The vertical axis of the graph is the multiplication factor Fm. The multiplication factor is in a range from zero percent to one hundred percent. In the present example, a composite portion Cm of a third digital image will be formed from the portion Am of the first digital image and a corresponding portion Bm of the second digital image. The image information in the portion Am from the first digital image will be multiplied by the multiplication factor Fm and this product will be added the product of the image information from the portion Bm in the second digital image multiplied by (1-Fm). Accordingly, if the luminance value L for portion Am (portion Am in this example is a pixel) of the first digital image is neither too dark nor too light (the calculated luminance of the pixel is in a first predetermined range of from 30 to 225), then the image information for portion Am in the first digital image is used (multiplied by a multiplication factor of 100%) and the image information for the corresponding portion Bm in the second image is ignored (is multiplied by zero). The first predetermined range is denoted by reference numeral 29 in FIG. 7.

If, on the other hand, the luminance value L for portion Am of the first digital image is too dark or too light (luminance L of the pixel is in a second predetermined range of from 0 to 15 or from 240 to 255), then the image information for portion Am in the first digital image is ignored (multiplied by a multiplication factor of 0%) and the image information for the corresponding portion Bm in the second image is used (multiplied by 100%). The second predetermined range is denoted by reference numeral 30 in FIG. 7.

The process of calculating a luminance value L for a portion Am of the first digital image and of then determining an associated multiplication factor Fm for portion Am is repeated n times for m equals one to n until a set of multiplication factors F1-Fn is determined. In the present example where a portion is a pixel, there is a one to one correspondence between the multiplication factors F1-Fn and the pixels A1-An of the first digital image.

Next (step 103), the multiplication factors F1-Fn are adjusted to reduce abruptness of transitions in the multiplication factors between neighboring portions. This adjusting process is explained in connection with a neighborhood of portions identified in FIG. 8 by reference numeral 31.

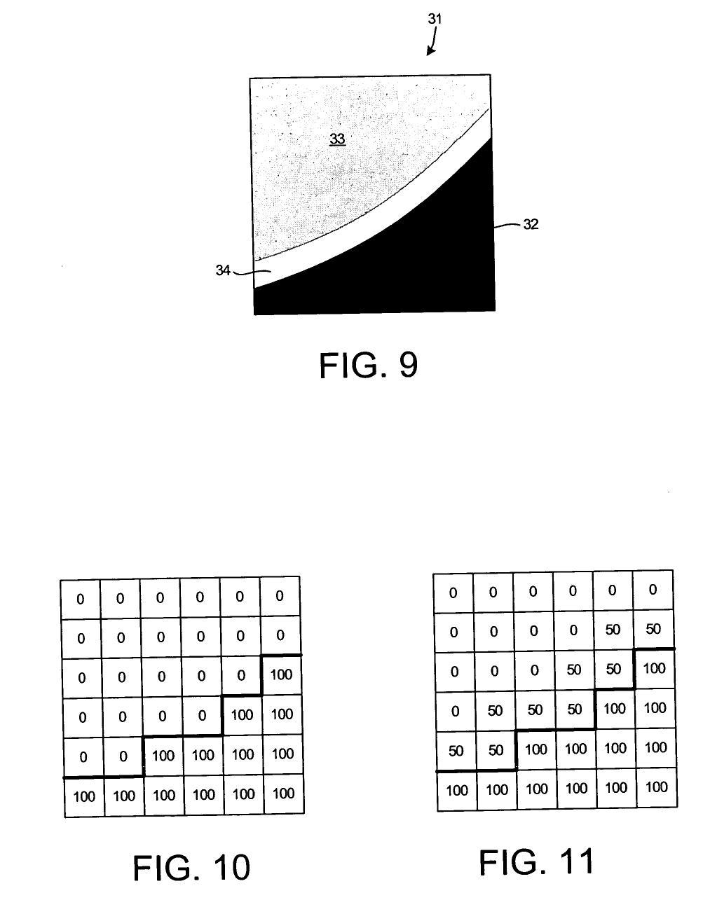

FIG. 9 is an expanded view illustrating luminance values L of the various portions within neighborhood 31. The darker region 32 to the lower right of FIG. 9 represents a part of the image of the dark tree of first portion 21 of the first digital image. The lighter region 33 to the upper left of FIG. 9 represents a part of the image of the bright sky of second portion 22 of the first digital image. A bright band 34 is disposed between the darker region 32 and the brighter region 33. Although band 34 is illustrated as having sharp well-defined edges, band 34 actually has somewhat fuzzy edges that extend into the sky portion of the image and into the tree portion of the image. When an image of a dark subject standing in front of a relatively bright light is captured, light originating from behind the object may appear to bend or reflect around the darker object in the foreground. This may be due the light reflecting off dust or moisture in the air and thereby being reflected around the object and toward the image sensor. The result is an undesirable “halo” effect in the captured image wherein a bright fuzzy halo is seen surrounding the contours of the dark object. Bright region 34 in FIG. 9 represents a part of such a halo that surrounds the contours of the tree.

In the example of the first and second digital images of FIGS. 4 and 6, the first portion (the tree) is properly exposed in the first digital image of FIG. 4 whereas the second portion (the sky) is properly exposed in the second digital image of FIG. 6. If the portions of the first digital image corresponding to the tree were associated with a multiplication factor of 100%, and if the portions of the first digital image corresponding to the sky were associated with a multiplication factor of 0%, then a two-dimensional array of multiplication factors such as that illustrated in FIG. 10 might result. If the first and second digital images were combined to form a third digital image using this two-dimensional array of multiplication factors, then the zeros in the array would cause the corresponding portions of the second digital image of FIG. 8 to appear unaltered in the final third digital image. Note, however, that the “halo” appears in the second portion of the second digital image of FIG. 6. Accordingly, if the array of multiplication factors of FIG. 10 were used in the combining of the first and second digital images, then the halo might appear in the resulting third digital image. This is undesirable.

Even if the halo were not to appear in the final third digital image, the sharpness of the transition of multiplication factors from 0% to 100% from one portion to the next may cause an unnatural looking boundary where first portion 21 of the first digital image 20 is joined to second portion 27 of the second digital image 25.

The multiplication factors determined in step 102 are therefore adjusted (step 103) to smooth out or dither the abrupt transition in multiplication factors. FIG. 11 illustrates the result of one such adjusting. In the example of FIG. 11, the multiplication factors are adjusted so that no two adjoining portions have multiplication factors that differ by 100%. If a portion having a multiplication factor of 100% is adjoining another portion having a multiplication factor of 0%, then the multiplication factor of the adjoining portion is changed from 0% to 50%. Note that this results in the smoothing out of the transition in the area of halo in region 24. This adjusting process is performed for the multiplication factors F1-Fn for all the portions A1-An of the first digital image.

Next (step 104), a composite portion Cm is generated for each portion C1-Cn of the third digital image by combining portion Am of the first digital image with portion Bm of the second digital image, wherein the combining is based on the multiplication factor Fm of the corresponding portion Am. In one example, the combining step is performed in accordance with Equations (2), (3) and (4) below.
RCm=(Fm*RAm)+((1−Fm)*RBm) (2)
GCm=(Fm*GAm)+((1−Fm)*GBm) (3)
BCm=(Fm*BAm)+((1−Fm)*BBm) (4)

The result is a red value RCm, a green value GCm, and a blue value BCm for portion Cm of the resulting third digital image. RAm is the red value for portion Am. GAm is the green value for portion Am. BAm is the blue value for portion Am. Parameter m ranges from one to n so that one portion Cm is generated for each corresponding portion A1-An in the first digital image.

Processor 2 (see FIG. 1) performs the combining of step 104 thereby generating the third digital image 35 comprising portions C1-Cn. Processor 2 then writes the third digital image 35 in the form of a file 38 into nonvolatile storage 19. The header 39 of the file 38 contains an indication 40 that the third digital image has been processed in accordance with an overexposure/underexposure compensating method. In some embodiments, the original first digital image and/or the original second digital image is also stored in non-volatile storage 19 in the event the user wishes to have access to the original images. Files of digital images containing the header with the indication can be transferred from the electronic device to other devices using the same mechanisms commonly used to transfer image files from an electronic consumer device to another electronic consumer device or a personal computer.

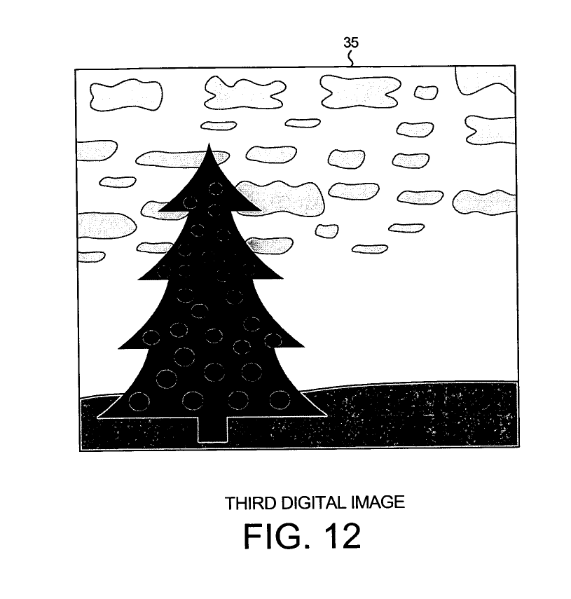

FIG. 12 is a representation of the third digital image 35. The detail and shading of first portion 21 of first digital image 20 of FIG. 4 is present in the third digital image 35 as is the detail and shading of second portion 27 of second digital image 25 of FIG. 6. The abruptness of the transitioning from image information from the first digital image to the second digital image is reduced, and the halo effect is reduced.

Although the method described above compensates for improper exposure using image information from multiple digital images, problems due to improper exposure can be ameliorated without the use of image information from multiple digital images.

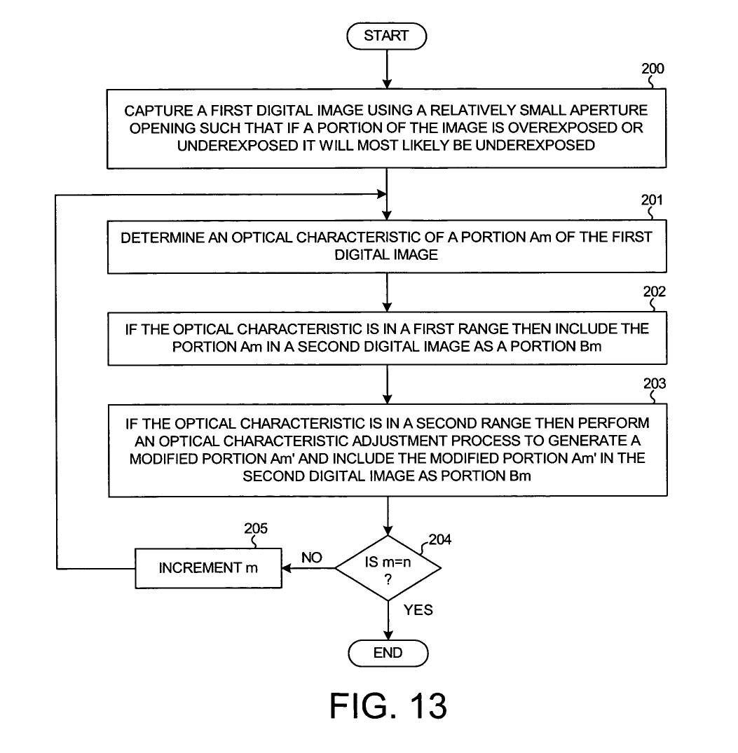

FIG. 13 is a flowchart of a second method in accordance with another novel aspect wherein information from a single digital image is used.

In a first step (200) a first digital image is captured using a relatively small aperture opening size such that if a portion of the image is overexposed or underexposed, it will most likely be underexposed. The first image is comprised of a two-dimensional array of portions Am, where m ranges from one to n.

Next (step 201), an optical characteristic of a portion Am is determined. In one example, the optical characteristic is pixel luminance L.

If the optical characteristic of portion Am is in a first range (step 202), then the image information in portion Am is included in a second digital image as portion Bm of the second digital image. Portion Am is included in second digital image in unaltered form.

If, however, the optical characteristic of portion Am is in a second range (step 203), then an optical characteristic adjustment process is performed on portion Am to generate a modified portion Am′. The modified portion Am′ is included in the second digital image as portion Bm.

In one example, portion Am is a pixel, the optical characteristic adjustment process is a screening process, the first range is an acceptable range of pixel luminance, and the second range is a range of unacceptably dark pixel luminance. If the pixel being considered has a luminance in the first range, then the pixel is included in the second image in unaltered form. If the pixel being considered has a luminance in the second range, then the pixel information of pixel Am is repeatedly run through the screening process to brighten the pixel. Each time the screening process is performed, the pixel is brightened. This brightening process is stopped when either the pixel luminance has reached a predetermined brightness threshold or when the screening process has been done on the pixel a predetermined number of times.

Equations (5), (6) and (7) below set forth one screening process.
(A−((A−RAm)*(A−RAm)>>8)=RAm′ (5)
(A−((A−GAm)*(A−GAm)>>8)=GAm′ (6)
(A−((A−BAm)*(A−BAm)>>8)=BAm′ (7)

In Equations (5), (6) and (7), A is a maximum brightness of a color value of the pixel being screened. RAm is a red color value of the portion Am that is an input to the screening process. RAm′ is a red color value output by the screening process. GAm is a green color value of the portion Am that is an input to the screening process. GAm′ is a green color value output by the screening process. BAm is a blue color value of the portion Am that is an input to the screening process. BAm′ is a blue color value output by the screening process. The “>>” characters represent a right shift by eight bits operation. As set forth above, the screening process is iteratively performed until pixel luminance has reached a predetermined brightness threshold or the number of iterations has reached a predetermined number. The screening process increases the luminance of the pixel while maintaining the relative proportions of the constituent red, green and blue colors of the pixel. The resulting color values Ram′, GAm′ and Bam′ are the color values of the modified portion Am′ that is included in the second digital image as portion Bm.

The optical characteristic adjustment process is repeated for all the portions A1-An of the first digital image such that a second digital image including portions B1-Bn is generated. This is represented in FIG. 13 by decision block 204 and increment block 205. When all portions A1-An have been processed, the test m=n in decision block 204 is true and the method is completed.

In step 200, if some pixels of the first digital image are improperly exposed, it is desirable that they be underexposed rather than overexposed. If individual sensors of the image sensor are saturated such that they output their maximum brightness values (for example, 255 for the red value, 255 for the green color value, and 255 for the blue color value) for a given pixel, then the relative amounts of the colors at the pixel location cannot be determined. If, on the other hand, the pixel is underexposed, then it may appear undesirably dark in the first digital image, but there is a better chance that relative color information is present in the values output by the individual color sensors. The relative amounts of the colors red, green and blue may be correct. The absolute values are just too low. Accordingly, when the pixel is brightened using the screening process, the resulting pixel included in the second digital image will have the proper color ratio. A relatively small aperture area is therefore preferably used to capture the first digital image so that the chance of having saturated image sensors is reduced.

Although certain specific embodiments are described above for instructional purposes, the present invention is not limited thereto. An optical characteristic other than luminance can be analyzed, identified in certain portions, and compensated for. In one example, the red, green and blue component color values of a pixel are simply added and the resulting sum is the optical characteristic of the pixel. A portion can be one pixel or a block of pixels. The portions of an image that are analyzed in accordance with the novel methods can be of different sizes. A starting digital image can be the RGB color space, or of another color space. A starting image can be of one color space, and the resulting output digital image can be of another color space. Although embodiments are described above that utilize a variable aperture, two fixed apertures of different aperture size openings can be employed to capture the first digital image and the second digital image. Rather than using different aperture settings to obtain the first and second digital images, the duration that an image sensor is exposed in a first digital image and a second digital image can be changed using an electronic shutter signal that is supplied to the image sensor. Other ways of obtaining the first and second digital images that have different optical characteristics can be employed. In one embodiment, one of the images is taken without flash artificial illumination, whereas the other image is taken with flash artificial illumination.

The method using the first and second digital images described above is extendable to include the combining of more than two digital images of the same scene. Digital images of different resolutions can be combined to compensate for improperly exposed areas of an image. Screening or another optical characteristic adjustment process can be applied to adjust an optical characteristic of a part of an image, whereas the combining of a portion of the image with a corresponding portion of a second image can be applied to compensate for exposure problems in a different part of the image. An optical characteristic adjustment process can change color values for only a certain color component or certain color components of a portion. The multiplication factor adjusting process can be extended to smooth an abrupt change in multiplication factors out over two, or three, or more portions. Color information in adjacent portions can be used to influence the optical characteristic adjustment process under certain circumstances such as where individual color sensors have been completely saturated and information on the relative amounts of the composite colors has been lost.

The disclosed methods need not be performed by a processor, but rather may be embodied as dedicated hardware. The disclosed method can be implemented in an inexpensive manner in an electronic consumer device (for example, a cellular telephone, digital camera, or personal digital assistant) by having a processor that is provided in the electronic consumer device for other purposes perform the method in software when the processor is not performing its other functions. A compensating method described above can be a feature that a user of the electronic consumer device can enable and/or disable using a switch or button or keypad or other user input mechanism on the electronic consumer device. Alternatively, the method is performed and cannot be enabled or disabled by the user. A compensating method can be employed with or without the multiplication factor smoothing process.

An indication that a compensating method has been performed can be displayed to the user of the electronic consumer device by an icon that is made to appear on the display of the electronic consumer device. An electronic consumer device can analyze a part of a first image, determine that the image has exposure problems, rapidly and automatically capture a second digital image of the same scene, and then apply a compensating method to combine the first and second digital images without knowledge of the user. Although optical characteristic adjustment methods are described above in connection with an electronic consumer device, the methods or portions of the methods can be performed other types of imaging equipment. The described optical characteristic adjustment methods can be performed by a general purpose processing device such as a personal computer. A compensation method can be incorporated into an image processing software package commonly used on personal computers such as Adobe Photoshop. Rather than using just one image sensor, a first image sensor can be used to capture the first digital image and a second image sensor can be used to capture the second digital image. Optical characteristic adjustment methods described above can be applied to images in one or more streams of video information. Accordingly, various modifications, adaptations, and combinations of the various features of the described specific embodiments can be practiced without departing from the scope of the invention as set forth in the claims.

What is claimed is:

1. A method for generating a third digital image from a first digital image and a second digital image, wherein the first digital image is of a scene and includes a plurality of portions A1-An, and wherein the second digital image is of substantially the same scene and includes a plurality of portions B1-Bn, wherein the portions A1-An of the first digital image are substantially in a one-to-one correspondence with the portions B1-Bn of the second digital image, the method comprising:
determining an optical characteristic of a portion Am of the first digital image;
combining the portion Am of the first digital image and the portion Bm of the second digital image to generate a composite portion Cm of the third digital image, wherein combining is based at least in part on the optical characteristic of the portion Am; and
repeating the determining and combining steps for a range 1≦m≦n such that composite portions C1-Cn are generated, wherein the composite portions C1-Cn together comprise at least a part of the third digital image.

2. The method of claim 1, wherein each of portions A1-An is a pixel, wherein each of the portions B1-Bn is a pixel, and wherein each of the portions C1-Cn is a pixel.

3. The method of claim 1, wherein the optical characteristic is a luminance characteristic.

4. The method of claim 1, wherein each of portions A1-An is a pixel, each pixel includes a red value, a green value, and a blue value, and the optical characteristic for the pixel is determined by summing the red value for the pixel, the green value for the pixel and the blue value for the pixel.

5. The method of claim 1, wherein combining the portion Am of the first digital image and the portion Bm of the second digital image comprises:
using the portion Am for the composite portion Cm if the optical characteristic of portion Am is within a first predetermined range; and
using the portion Bm for the composite portion Cm if the optical characteristic of portion Am is within a second predetermined range.

6. The method of claim 1, wherein combining the portion Am of the first digital image and the portion Bm of the second digital image is in accordance with the equations:
RCm=(Fm*RAm)+((1−Fm)*RBm) (2)
GCm=(Fm*GAm)+((1−Fm)*GBm) (3)
BCm=(Fm*BAm)+((1−Fm)*BBm) (4)
wherein Fm is a multiplication factor in a range of zero and one and Fm is determined based at least in part on the optical characteristic of portion Am, RAm is a red value for portion Am, RBm is a red value for portion Bm, RCm is a red value for portion Cm, GAm is a green value for portion Am, GBm is a green value for portion Bm, GCm is a green value for portion Cm, BAm is a blue value for portion Am, BBm is a blue value for portion Bm, and BCm is a blue value for portion Cm.

7. The method of claim 1, wherein repeating the determining and combining steps further comprises:
first determining the optical characteristic for each of portions A1-An; and
performing the combining multiple times to generate the composite portions C1-Cn.

8. The method of claim 1, wherein combining the portion Am of the first digital image and the portion Bm of the second digital image comprises:
generating a multiplication factor Fm for each portion Am, the portions A1-An including interior portions and boundary portions, wherein each interior portion has multiple neighboring portions; and
adjusting the multiplication factors of at least some of the portions A1-An to reduce an abruptness of a transition in the multiplication factor between an interior portion and its neighboring portions.

9. The method of claim 1, further comprising:
capturing the first digital image using an image sensor; and
capturing the second digital image using the image sensor.

10. The method of claim 1, further comprising:
capturing the first digital image using a first aperture setting; and
capturing the second digital image using a second aperture setting.

11. The method of claim 10, further comprising:
automatically capturing the first digital image and the second digital image in rapid succession.

12. The method of claim 10, wherein the method is performed by an electronic device, and the method further comprises:
in response to receiving an input from a user placing the electronic device into a mode, wherein operation in the mode causes the electronic device to capture the first and second digital images in rapid succession, and wherein operation in the mode causes the method of claim 10 to be performed such that the third digital image is generated.

13. An electronic device comprising:
an image sensor that captures a first digital image and a second digital image; and
means for determining an optical characteristic of a portion Am of the first digital image and if the optical characteristic is in a first range then including the portion Am as a portion Cm of a third digital image, whereas if the optical characteristic is in a second range then generating a composite portion by combining portion Am of the first digital image and a corresponding portion Bm of the second digital image, wherein the combining is based at least in part on the optical characteristic of portion Am, the means including the composite portion as the portion Cm of the third digital image.

14. The electronic device of claim 13, wherein the electronic device is a wireless communication device, the wireless communication device comprising radio electronics, wherein the means is a processor in the wireless communication device, and wherein the processor also controls the radio electronics.

15. The electronic device of claim 13, further comprising:
a variable aperture, the means controlling the variable aperture such that the first digital image is captured using a first aperture setting and such that the second digital image is captured using a second aperture setting.

16. The electronic device of claim 13, wherein the portion Am is a pixel, and wherein the optical characteristic is a luminance of the portion Am.

17. The electronic device of claim 13, wherein the means is also for storing the third digital image as a file, the file having a header, the header including an indication that image processing has been performed on the third digital image.

18. The electronic device of claim 13, further comprising:
a switch usable by a user to place the electronic device into a mode, wherein operation in the mode causes the second digital image to be captured automatically after the first digital image is captured, and wherein operation in the mode causes the third digital image to be generated.

19. A wireless communication device comprising:
an image sensor that captures a first digital image using a first aperture setting and a second digital image using a second aperture setting, wherein the first digital image and the second digital image are of substantially the same scene;
radio electronics;
a processor that communicates with and controls the radio electronics; and
a memory that stores a set of instructions, the set of instructions being executable on the processor, the set of instructions being for performing steps comprising:
(a) determining an optical characteristic of a portion Am of the first digital image;
(b) generating a composite portion by combining portion Am of the first digital image and a corresponding portion Bm of the second digital image, wherein the combining is based at least in part on the optical characteristic of portion Am determined in step (a), the composite portion being included as a portion of a third digital image; and
(c) storing the third digital image as a file on the cellular telephone.

20. A method comprising:
(a) determining an optical characteristic of a portion Am of the first digital image;
(b) if the optical characteristic meets a first criterion then including the portion Am in a second digital image, whereas if the optical characteristic meets a second criterion then performing an optical characteristic adjustment process on the portion Am to generate a modified portion Am′ and including the modified portion Am′ in the second digital image; and
(c) repeating steps (a) and (b) for m equals 1 to n such that composite portions C1-Cn are generated, wherein the composite portions C1-Cn together comprise at least a part of the second digital image.

21. The method of claim 20, wherein the portion Am is a pixel of the first digital image, wherein the pixel has a red color value, a green color value and blue color value, wherein the optical characteristic is a luminance characteristic of the pixel, and wherein the optical characteristic adjustment process is a screening process.

22. The method of claim 21, wherein the optical characteristic adjustment process involves applying the equations (A−((A−RAm)*(A−RAm)>>8)=RAm′, (A−((A−GAm)*(A−GAm)>>8)=GAm′, (A−((A−BAm)*(A−BAm)>>8)=BAm′, wherein A is a maximum brightness of a color value of a pixel in the first digital image, wherein RAm is a red color value of the portion Am, wherein RAm′ is a red color value of the modified portion Am′, wherein GAm is a green color value of the portion Am, wherein GAm′ is a green color value of the modified portion Am′, wherein BAm is a blue color value of the portion Am, and wherein BAm′ is a blue color value of the modified portion Am′.

23. The method of claim 20, wherein the optical characteristic is a luminance characteristic, and wherein the optical characteristic adjustment process is a screening process that is repeatedly performed in step (b) until either: 1) the optical characteristic of the modified portion Am′ reaches a threshold for the optical characteristic, or 2) the screening process is repeated a predetermined maximum number of times.

24. The method of claim 20, wherein the first criterion is a first luminance range, wherein the second criterion is a second luminance range, the second luminance range representing luminance values greater than luminance values in the first luminance range.

25. The method of claim 20, further comprising:
capturing the first digital image in an electronic device, wherein steps (a), (b) and (c) are performed by the electronic device; and
displaying the second digital image on a display of the electronic device.

26. A wireless communication device, comprising:
an image sensor that captures a first digital image, wherein the first digital image includes a plurality of portions Am where m ranges from 1 to n, and wherein each portion Am has an optical characteristic;
radio electronics; and
a processor that communicates with and controls the radio electronics, wherein the processor includes the portion Am in a second digital image if the optical characteristic of the portion Am meets a criterion, whereas if the optical characteristic does not meet the criterion then the processor performs an optical characteristic adjustment process on the portion Am to generate a modified portion Am′ and includes the modified portion Am′ in the second digital image.

27. The wireless communication device of claim 26, wherein the portion Am is a pixel and wherein the optical characteristic is a luminance, and wherein the optical characteristic adjustment process is a screening process.

28. The wireless communication device of claim 27, further comprising:
a switch usable by a user to place the wireless communication device into one of a first mode and a second mode, wherein operation in the first mode results in the optical characteristic adjustment process being performed on the portion Am if the portion Am meets the criterion, and wherein operation in the second mode disables the optical characteristic adjustment process.

29. The wireless communication device of claim 26, wherein the optical characteristic adjustment process is a screening process.

30. The wireless communication device of claim 26, wherein the processor is a processor that executes a plurality of computer-executable instructions stored on a computer-readable medium, the computer-readable medium being a part of the wireless communication device.

31. The wireless communication device of claim 26, wherein the second digital image includes portions that are identical to corresponding portions in the first digital image, and wherein the second digital image includes portions that are modified versions of corresponding portions in the first image, the modified versions being modified using the optical characteristic adjustment process.

32. The wireless communication device of claim 31, further comprising:
a memory, wherein the second digital image is stored as a file in the memory.

33. An electronic device comprising:
an image sensor that captures a first digital image, the first digital image including a plurality of portions Am where m ranges from 1 to n, wherein each of the portions Am has an optical characteristic; and
means for including the portion Am in a second digital image if the optical characteristic of portion Am is in a first range, whereas if the optical characteristic is in a second range then performing an optical characteristic adjustment process on the portion Am to generate a modified portion Am′ and including the modified portion Am′ in the second digital image.

34. The electronic device of claim 33, wherein the second digital image includes portions that are not modified by the optical characteristic adjustment process, and wherein the second digital image includes portions that are modified by the optical characteristic adjustment process.

35. The electronic device of claim 34, wherein the means is a processor that executes a plurality of computer-executable instructions.

36. The electronic device of claim 35, wherein the electronic device is a cellular telephone, the electronic device further comprising:
radio electronics, wherein the means is also for communicating with and controlling the radio electronics.

37. The electronic device of claim 33, wherein the optical characteristic is a luminance, and wherein the optical characteristic adjustment process adjusts luminance.

38. The electronic device of claim 33, wherein the means is also for storing the second digital image as a file.

39. The electronic device of claim 33, wherein each of the plurality of portions Am is a pixel.

40. The electronic device of claim 33, wherein each of the plurality of portions Am is a block of pixels.
